(19) United States
(12) Patent Application Publication
(10) Pub. No.: US 2024/0075870 A1
(43) Pub. Date: Mar. 7, 2024

(54) METHOD FOR OPERATING AN ENVIRONMENT LIGHTING DEVICE OF A VEHICLE

(71) Applicant: MERCEDES-BENZ GROUP AG, Stuttgart (DE)

(72) Inventors: Klemens PREY, Horb am Neckar (DE); Gabriel HAAG, Villingendorf (DE)

(73) Assignee: MERCEDES-BENZ GROUP AG, Stuttgart (DE)

(21) Appl. No.: 18/272,623

(22) PCT Filed: Nov. 17, 2021
(86) PCT No.: PCT/EP2021/081921

§ 371 Date: Jul. 17, 2023

(30) Foreign Application Priority Data
Jan. 19, 2021 (DE) 10 2021 000 247.4

(51) Int. Cl. B60Q 1/24; B60Q 1/26; B60Q 3/70; B60R 25/104; B60R 25/31

(52) U.S. Cl. CPC B60Q 1/247; B60Q 1/2619; B60Q 3/70; B60R 25/104; B60R 25/31

(57) ABSTRACT

A method for operating an environment lighting device of a vehicle involves the environment lighting device emitting at least one light pattern into an environment of the vehicle by at least one lighting assembly depending on a control command. The environment lighting device is set to a standby mode by inputting a control action. The environment lighting device emits light when an authorized person nears the vehicle while the environment lighting device is in standby mode.

### BACKGROUND AND SUMMARY OF THE INVENTION

Exemplary embodiments of the invention relate to a method for operating an environment lighting device of a vehicle and to a vehicle having such a lighting device.

A so-called coming-home, follow-me-home, or leaving-home equipment package is often available for a vehicle. This might be a particular lighting device or a method for operating the lighting device, for example. Using the lighting device, it is possible to light a typically dark portion of the environment around the vehicle if the vehicle is stationary or driving slowly. While vehicle headlights serve to light a road portion driven over by the vehicle in darkness so that a person driving a vehicle can also operate the vehicle safely at night, and indicator lights such as indicators emitting an indication of a dangerous situation and to indicate a lane change or turning process, the coming-home or leaving-home function contrastingly serves to enable the person driving the vehicle safe access to the vehicle or safe parking of the vehicle. A so-called light carpet can thus be generated around the vehicle with the lighting device, for example, using which for example fallen objects such as dropped keys can be more easily found. Illuminating the environment also enables the vehicle to be more easily loaded or unloaded in darkness.

Environment regions can also be illuminated in a targeted manner, for example to light a path leading towards or away from the vehicle. A danger of stumbling for a person nearing the vehicle or a person leaving the vehicle is thus reduced, and third parties can be lit, for example an attacker hidden in a parking garage, to indicate the danger to the person driving the vehicle. The person driving the vehicle's feeling of safety is thus also increased. The coming-home function is typically activated when parking the vehicle, which can be determined via deactivation of a drive engine of the vehicle, removal of an ignition key from an ignition lock, opening of vehicle doors, and/or locking of the vehicle.

By contrast, the leaving-home function is activated when entering the vehicle. Entering the vehicle is correspondingly recognized, for example, by an unlocking command being sent to the vehicle, vehicle doors being opened and/or a person driving the vehicle nearing the parked vehicle. The environment lighting device comprises different lighting assemblies for emitting light, typically such as lights provided on a vehicle, such as front and/or rear headlights, number plate lighting, entry and exit lighting integrated in doors or a vehicle frame or additionally lights integrated in recessed grips or wing mirrors. There are no limits set on a plurality of light patterns cast in the environment. Light patterns of the most varied shapes, colors, patterns, sizes, display durations and having different lighting dynamics are thus known from the prior art.

Such a lighting device is disclosed, for example, in DE 199 36 357 A1. Using the lighting device, a preferably continuous or uninterrupted light carpet is generated around a vehicle, using which the vehicle can be more easily loaded and/or unloaded in darkness and to increase a feeling of safety of a person using the vehicle. The lighting device is activated if an environment brightness measured using a brightness sensor simultaneously falls below a fixed value, and an activation command transmitted via a remote control is received by the vehicle. The remote control can also comprise a central lock of the vehicle. The lighting device can thus be activated simultaneously when opening and closing the vehicle. It is also possible to regulate a brightness emitted by the lighting device depending on the environment brightness. Power of individual light elements can be increased or reduced for this purpose, and a number of lights switched on can be varied. The lighting device is automatically deactivated after a pre-determined duration, or alternatively also after a drive engine of the vehicle has been started or after a pre-determined duration has passed after all the doors of the vehicle have been closed. The lighting device can use a parking light of the vehicle, rear lights, mirror footlights, bumper lights, interior lighting of the vehicle, and door entry lights and number plate lighting as a lighting means. All or individual specified lighting means can be controlled in a targeted manner. By inputting manual control actions, a number of activated lights and their brightness can also be freely adjusted or the lighting device can be activated and deactivated. A particularly high feeling of safety is generated by generating the light carpet cast into the environment around the vehicle by the lighting device such that it is continuous and thus as uninterrupted as possible.

A further environment lighting device and a corresponding method for operating the environment lighting device are known from DE 10 2012 024 513 A1. In the case of the lighting device disclosed in this document, a person is in the position to adjust the way in which the lighting device casts light into the environment to match their personal preferences. A light propagation direction, a light propagation angle, and a brightness of the emitted light can be adjusted. Several profiles with different settings can also be saved. Using a camera, in particular a so-called surround-view camera, and a corresponding display to display camera images, environment regions around the vehicle with poor visibility can also be easily seen in order to check whether the adopted light settings are as desired. The settings can, for example, be applied via a head unit of the vehicle, a vehicle key and/or a mobile device such as a smartphone on which a corresponding app is executed. A continuous environment around the vehicle can preferably be lit with the lighting device. To activate the lighting device it is required to manually issue an activation command. It can also be required to input an activation command twice in series to prevent undesirable activation of the lighting device. The lighting device can use all conventional lighting means as a lighting means, such as light bulbs, halogen bulbs, gas-discharge lamps, fluorescent lamps and/or light-emitting diodes (LEDs).

DE 10 2013 016 347 A1 also discloses a lighting device for a vehicle. The lighting device is, in particular, used as an entry and exit light for the vehicle. The lighting device comprises at least one projector, using which digital information such as text, images and/or logos are cast into an environment in the vicinity of a vehicle door when entering and exiting the vehicle. To activate the lighting device, a control command is emitted depending on a door contact. If, for example, the door is opened, then the lighting device is activated. It is also possible to additionally recognize a person nearing the vehicle using a motion sensor and to automatically activate the lighting device as soon as a person nears the vehicle. Deactivating the lighting device can occur in stages. After a first time duration, the transmission of the information is stopped and after a further, longer duration, background lighting is also deactivated. To provide the digital information in the vehicle, mobile storage media, e.g., a USB stick or a memory card or also a mobile device, can be used. Data transmission is possible via radio, or also via cable, for example. For example, a red light carpet can be emitted by the lighting device, for example to give a person entering or exiting the vehicle the feeling of stepping on a red carpet.

A light arrangement of a motor vehicle and an environment lighting device having such an arrangement is additionally known from DE 10 2017 119 919 A1. Environment conditions around a vehicle are continuously recorded using sensors and light segments of the environment lighting device are dynamically and continuously controlled depending on the measured environment conditions. Using the environment lighting device, dynamics in a light pattern cast into the environment can thus also be generated, e.g., movements, pulsing, changes in brightness, changes in color, moving patterns and/or other characteristics corresponding to animation. A continuous environment around the vehicle is preferably also lit. Weather conditions, an operating state of the vehicle, a charging state of a traction battery, an autonomous driving mode and/or an error state are in particular evaluated as environment conditions. For example, a vehicle type can be shown by a light color. Thus, for example, the environment lighting device emits yellow light in the case of a vehicle driven by electric battery, and red light in the case of a vehicle having an internal combustion engine. Thus, for example, the charge state can also be shown at a charging station when charging the traction battery of a vehicle driven by electric battery. Thus, red light is emitted when a battery is empty, yellow light is emitted when a battery is partially charged, and green light is emitted when a battery is fully charged. This is, in particular, advantageous for rented and/or car-share vehicles. In addition to the recorded environment conditions, a characteristic of the light emitted by the environment lighting device can also be controlled depending on a presence and a position of a particular person in relation to the vehicle and an identity of the person. To detect the person, camera images generated using a camera can, for example, be evaluated. For example, a position of the person is recorded, and in particular an environment region around the person is illuminated more brightly, so that the person can find fallen objects more easily or indicate other people to the illuminated person. Thus, for example, attackers can be more easily recognized. The document also discloses saving light characteristics depending on a geoposition of the vehicle. If, for example, the vehicle parks in a first location, then a first light characteristic is used, and if the vehicle parks in a second location, a second light characteristic differing from the previous is used. Thus, for example, when the vehicle is parked in a private garage, the garage can be lit, and when the vehicle is parked in a company car park, the environment can be lit particularly discreetly.

Exemplary embodiments of the present invention are directed to advantageously further developing methods known from the prior art for operating an environment lighting device of a vehicle.

In a method for operating an environment lighting device of a vehicle of the kind specified in the introduction, according to the invention, the environment lighting device is set to a standby mode by inputting a control action, wherein the environment lighting device emits light when an authorized person nears the vehicle while it is operated in the standby mode.

It is known from the state of the art to activate an environment lighting device of a vehicle automatically when a person nears the vehicle, for example using a motion sensor. It can be the case, however, that the environment lighting device is activated although it is not required, for example because uninvolved people walk past the vehicle. Unnecessary load is thus put on a vehicle battery, and the battery thus discharges quicker. To prevent this from happening, the environment lighting device is only activated if an authorized person nears the vehicle. In this case too, however, it can be the case that an activation of the environment lighting device is undesirable. When the authorized person sets the environment lighting device to the standby mode however, the authorized person can ensure that the environment lighting device is only activated when this is desired by the authorized person. If an automatic activation of the environment lighting device is undesirable for a long period of time, for example, the authorized person is thus in the position to deactivate the standby mode, whereupon the environment lighting device does not emit any light even when the authorized person nears the vehicle. Comfort when using the environment lighting device is thus increased, and unnecessary energy usage is reduced.

Inputting the control action for setting the environment lighting device to the standby mode is possible in many ways. For example, input can occur for this purpose via a head unit of the vehicle. It is also conceivable that physical buttons, switches, rotary knobs, or the like are provided on an instrument panel of the vehicle. It is also conceivable to input the control action via a mobile device, such as a smartphone, tablet, laptop or the like, and by means of a vehicle key. The standby mode remains activated until it is manually deactivated by input of a new control action. It is also conceivable that the standby mode is automatically deactivated and/or reactivated depending for example on an elapsed duration, a stretch of road travelled with the vehicle or a location of the vehicle.

The environment lighting device can emit any light pattern into the environment of the vehicle. For example, the light pattern can be formed continuously, and thus uninterrupted around the vehicle. For example, the light pattern can extend up to a distance of approx. 1 m around the vehicle. It is also possible, however, that the light pattern is interrupted at least along a peripheral portion around the vehicle, for example in the region of the vehicle front. The environment lighting device can comprise different lighting assemblies, for example vehicle headlights, projectors, auxiliary lights, or the like. All conventional lighting means, such as light bulbs, halogen bulbs, fluorescent tubes, LEDs, lasers, or the like can also be used as lighting means. The light pattern can have any brightness, extension, color, information content in the form of text, images, logos and/or dynamics. It is also possible that a brightness of the environment is monitored using a brightness sensor, and light is only emitted by the environment lighting device from a certain degree of darkness in the environment.

An advantageous development of the method provides that a person is recognized as an authorized person with at least one of the following methods:
entering an identification transmitter in a detection range of an identification system of the vehicle, wherein, in particular, a vehicle key, transponder, and/or a mobile device is used as an identification transmitter;
evaluating at least one camera image generated by at least one vehicle camera, in particular using facial recognition; and/or
evaluating an audio signal output by at least one vehicle microphone, wherein the audio signal, in particular, comprises at least one key word and/or key sentence spoken by the authorized person, and wherein vocal characteristics of the authorized person are preferably analyzed.

Using the methods listed, it is possible to recognize an authorized person particularly reliably. This occurs automatically if the authorized person nears the vehicle, which increases comfort when using the environment lighting device. If the authorized person nears the vehicle, which is, in particular, recognized by an identification transmitter coming into a detection range of the identification system, then the environment lighting device is automatically activated. If, for example, the authorized person is carrying objects, and thus does not have a hand free, they can near the vehicle in darkness, whereupon the vehicle automatically lights up the vehicle environment. Comfort for the authorized person can thus be increased, as no control actions need to be input to light the vehicle environment, which would require the person to put down the carried objects. A detection range can be of the order of magnitude of a typical range of a radio key, for example 1 to 40 m.

As a mobile device such as a smartphone, tablet, or the like is used as an identification transmitter, automatic activation of the environment lighting device can also be implemented when using a so-called key-less-go system.

It is also conceivable to recognize the authorized person using a camera image. This further increases comfort when using the environment lighting device, as it is also possible to recognize the authorized person, and thus to activate the environment lighting device if the authorized person is not carrying the identification transmitter. For this purpose, a photo or a video can be recorded in advance and saved in the vehicle so that the vehicle has information about which person is an authorized person. The camera image of the authorized person can also be taken outside of the vehicle, for example, via a photo camera or a mobile device, such as a smartphone, and transmitted wirelessly to the vehicle. This further increases comfort when using the environment lighting device. If, for example, the vehicle is a transporter used by a company, an owner of the transporter can, for example, transmit a photo of a new colleague to the vehicle so that it recognizes the new colleague as an authorized person even when first used by the new colleague.

Recognition of the authorized person, and thus activation of the environment lighting device is also possible by voice. Such a function is also known, for example, via so-called voice assistants. This also allows a person who does not have a hand free to comfortably and easily activate the environment lighting device. For this purpose, the authorized person can say a key word and/or a key sentence, for example “hey vehicle, activate the environment lighting device”, whereupon the environment lighting device is activated. For this purpose, the person can, for example, be recognized using their vocal characteristics. It is also possible that the authorized person is recognized via the identification transmitter and/or by evaluation of a camera image, but a voice command must be issued in addition to activate the environment lighting device. Voice detection is achieved by means of at least one microphone recorded by the vehicle. This microphone is in the position to detect noises outside of the vehicle. As an alternative, or in addition, a microphone of a mobile device coupled with the vehicle can be used.

Corresponding to a further advantageous embodiment of the method, if a vehicle occupant wishes to leave the vehicle, a light pattern is cast into the environment by means of the environment lighting device, wherein the light pattern has a different color, shape, surface area, pattern, brightness, luminous range, and/or dynamics depending on whether it is possible to exit without risk or whether there is a risk of a potential accident. A particularly secure exit of the vehicle is thus guaranteed. On the one hand, the vehicle occupant can be warned about a nearing further traffic participant, such as a passenger car or heavy goods vehicle, but also a cyclist, to prevent the vehicle occupant from opening the vehicle door, whereby the further traffic participant would have driven into the vehicle door. The further traffic participant can also be warned of the person getting out of the vehicle by the further traffic participant perceiving the light pattern cast into the environment. To recognize that it is possible to exit the vehicle without risk, an environment of the vehicle is monitored with tried and tested environment monitoring systems. For example, a region in the direction of a vehicle front is monitored using a multi-purpose camera and a rear region of the vehicle is monitored using a rear view camera of a parking aid and/or using rear view cameras used as a replacement for wing mirrors. By evaluating camera images generated by the camera, further traffic participants and, in particular, a position of the further traffic participants relative to the vehicle can then, for example, be determined. It is also possible to monitor the vehicle environment using spacing sensors. Thus, for example, radar sensors, ultrasound sensors, and/or laser scanners can be used. The nearing of a further traffic participant, in particular in a region entered when opening a vehicle door, can thus be reliably recognized. To recognize the desire of a vehicle occupant to exit, different methods can also be used. For example, a vehicle interior can be monitored using a camera to recognize and evaluate movements of the vehicle occupants. Parking the vehicle, which is for example recognized by deactivating a drive device of the vehicle, can also indicate an imminent door opening process. Navigation data can also be evaluated. If, for example, the vehicle reaches a navigation goal that has been programmed in, this means, for example, that a person driving the vehicle would like to leave the vehicle. Touch sensors can also be integrated into door grips of the vehicle that output a signal if a vehicle occupant touches and/or operates the door grip.

If it is possible to exit without risk, the environment lighting device casts, for example, a green triangle of light in an immediate environment in front of the vehicle door out of which the vehicle occupant would like to exit. A message can also be projected into the triangle, for example text such as “okay”, “exit!” or “safe”. If, however, there is a risk of an accident when opening a vehicle door, then the environment lighting device casts a red triangle of light into the environment region in front of the vehicle door, for example. Analogously, a corresponding warning such as warning text or a warning symbol such as lightning or an exclamation mark can be projected into the triangle of light. For example, warning text such as “attention!” or “warning” or “stop” can be output. In addition, or as an alternative, the light pattern can be provided with dynamics. Thus, for example, the light pattern can pulse like a stroboscope. It is also possible to implement the output of the light pattern in stages. If, for example, it is recognized that a door grip has been touched, the light pattern glows red continuously. If the exiting person is thus prevented from exiting and begins to further open the door, an output of the light pattern can occur with dynamics, for example the light pattern can begin to flash. A reliability of the exiting person still recognizing the danger warning in time and still stopping the door from being opened in time can thus be increased. It is also conceivable that the door grips of the vehicle are provided with a safety function and the door can be opened only if it is possible to exit without risk. As a malfunction can occur, a bypass solution for bypassing the door lock can also be provided. For example, a door can be operated several times for this purpose or be pulled to a second pull point via a first pull point so that a door opening can be carried out even when a door is locked.

As the light pattern is projected into the environment of the vehicle by the environment lighting device, the further traffic participants are also in the position to perceive the light pattern. The further traffic participants are thus also warned of the potential exit of the vehicle occupant, and can optionally also carry out an avoidance maneuver. Traffic safety is thus improved.

A further advantageous embodiment of the method further provides that as an alternative to, or in addition to, the light pattern casting into the environment, interior lighting of the vehicle is activated depending on a safe or unsafe exit. Safety in road traffic can thus be further improved. Thus, for example, a green door interior grip lighting can occur if a safe exit is possible and said door interior grip lighting can be red if there is a threat of a collision with a further traffic participant. A vehicle occupant can thus be warned of the danger in advance if they would like to exit, whereupon the vehicle occupant does not even try to open a door. The interior lighting can also be designed in any way. For example, a brightness, color, display duration, dynamics or the light of the interior lighting can be changed if a dangerous exit is detected instead of a safe one.

Corresponding to a further advantageous development of the method, when an attempted break-in and/or damage to the vehicle is detected, the environment lighting device emits light, wherein the environment lighting device exclusively illuminates a relevant environment region. An attempted break-in or damage to the vehicle can be recognized, for example, using inertial sensors and/or vehicle interior monitoring, for example by means of an interior camera. The damage to the vehicle can be a parking bump, for example. In such a situation, it is, for example, known to activate a hazard light of the vehicle. Attackers are thus frightened off and/or third-parties are alerted to the attempted break-in and/or the damage to the vehicle. By the relevant environment region being illuminated using the environment lighting device as an alternative or in addition to the activated hazard lights, the cause of an accident can be pinpointed in a targeted manner to the spot at which the vehicle was damaged and/or an attacker of the vehicle can be lit so that this person can for example be more easily recognized. Safety of the vehicle can thus be improved.

Information is preferably projected into the environment by means of the environment lighting device at least when at least one vehicle door is opened, wherein information content is changed depending on seat occupation of a vehicle seat neighboring the opened door, wherein seat occupation is monitored, in particular, by means of camera monitoring of the vehicle interior and/or by means of a seat occupation sensor. It can thus be recognized whether a person intends to enter or exit the vehicle. If the vehicle door is opened and it is determined that a seat neighboring the door is occupied, this means that a vehicle occupant intends to leave the vehicle. If the vehicle door is opened and an empty vehicle seat is determined, this indicates that a person would like to take a seat in the vehicle. Thus, when leaving the vehicle, farewell text such as “see you soon” or “goodbye” and/or additionally any information such as messages or a weather report can for example be projected into the environment. If, however, it is recognized that a person would like to take a seat in the vehicle, a text message such as “welcome” or “hello” can for example be projected into the environment. This is, in particular, aligned such that it appears the right way up for a person leaving the vehicle or entering the vehicle. A particular experience is thus generated when using the vehicle. Using a seat occupation sensor and vehicle interior monitoring by means of a camera, it is possible to reliably and easily recognize whether a person would like to enter or exit the vehicle.

In the case of a vehicle having a lighting device, at least one control device and an identification system, the control device is equipped according to the invention to carry out a method previously described. The vehicle can be any vehicle, such as a passenger car, heavy goods vehicle, transporter, van, bus, or the like.

An advantageous development of the vehicle provides that at least one lighting assembly of the lighting device, in particular a projector equipped to show information, is integrated into a sill cladding, undercarriage cladding and/or a bumper of the vehicle. By providing the lighting assembly in the sill cladding, undercarriage cladding, and/or bumper, a particularly subtle integration of the lighting assembly into the vehicle is possible, which improves aesthetics of the vehicle. Relevant environment regions around the vehicle can additionally be particularly reliably recognized by the lighting assembly, as the lighting assembly is arranged with a comparatively low spacing from the environment. A danger is thus reduced of disrupting objects being located in a light beam path emitted by the lighting assembly, which could cause a shadow in a light pattern caused by the lighting assembly. In particular, an uninterrupted light carpet can be generated, at least along a peripheral portion around the vehicle. It is most particularly advantageous if the continuous light carpet reaches from a lateral vehicle front via a vehicle rear to a lateral vehicle front lying opposite the first vehicle front. If, for example, a person loses an object, the object can more easily be found in darkness, as the lighting assembly lights all relevant regions around the vehicle. Light emitted by the lighting assembly can also reach at least partially under the vehicle, for example in order to also be able to locate an object that has rolled under a vehicle.

The vehicle preferably has exactly five lighting assemblies, wherein two lighting assemblies are respectively arranged on a left and right side of the vehicle when viewed in relation to a longitudinal axis of the vehicle and one lighting assembly is arranged at the rear of the vehicle and the lighting assemblies are in particular equipped to project an interrupted light pattern into the environment. By providing exactly five lighting assemblies, a lighting assembly can be provided under each vehicle door in the case of a five-door vehicle. A relevant vehicle environment region can thus be particularly reliably lit up. As the lighting assemblies are arranged around the vehicle, an uninterrupted light pattern around the vehicle can additionally be generated particularly easily. Any conventional lighting assembly can thus be used as a lighting assembly. For example, headlights, marker lights, projectors, or the like can, for example, be used. These can have different lighting means such as light bulbs, LEDs, lasers, or the like. To control a lighting device and/or a control angle with which light emitted by the lighting assembly is cast into the environment, the lighting assemblies can have different components, such as lenses, reflectors, prisms, mirrors, filters, or the like and corresponding actuators to move these elements.

Further advantageous embodiments of the method according to the invention and the vehicle result from the exemplary embodiments, which are described in more detail in the following and with reference to the figures.

### BRIEF DESCRIPTION OF THE DRAWING FIGURES

In the figures:

FIG. 1 shows a schematic depiction of vehicle components arranged in a vehicle for carrying out a method according to the invention;

FIG. 2 shows a schematic view of a vehicle according to the invention that casts a continuous light carpet into a vehicle environment around the vehicle; and

FIG. 3 shows a schematic depiction of a traffic situation in which a person exiting a vehicle is warned about further traffic participants.

### DETAILED DESCRIPTION

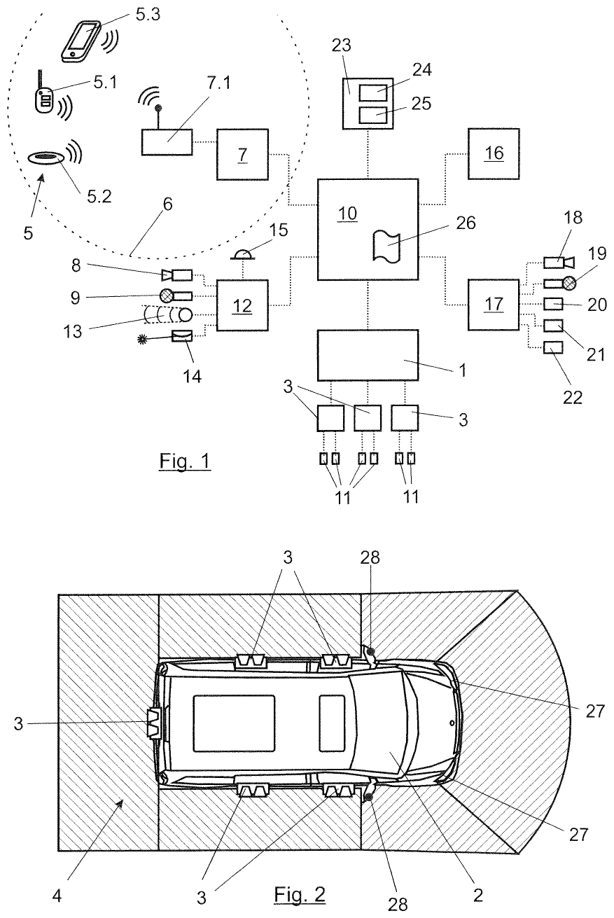

FIG. 1 shows components of a vehicle 2 shown in FIG. 2, using which a method according to the invention can be carried out. The vehicle 2 comprises a central control device 10, for example a central on-board computer and/or a computer of a head unit of the vehicle 2. Different sub-systems are connected to the control device 10 via a data connection such as a data bus. The control device 10 transmits control commands onto an environment lighting device 1, using which a light pattern can be cast into an environment around the vehicle 2. The environment lighting device 1 comprises several lighting assemblies 3, of which three are depicted in FIG. 1. The lighting assemblies 3 can, for example, be a matrix headlight, a projector, or a marker light. The lighting assemblies 3 comprise several lighting means 11 in turn, two of which are depicted in FIG. 1 for each lighting assembly 3. LEDs, light bulbs, lasers, or the like can, for example, be used as lighting means 11. To generate a control command in the environment lighting device 1 to activate at least one lighting assembly 3, the control device 10 comprises sensor data from different systems. The environment lighting device 1 is thus activated if an authorized person is located near the vehicle 2. This can for example be determined by an identification transmitter 5, here for example in the form of a vehicle key 5.1, a transponder 5.2, and a mobile device 5.3 entering a detection range 6 of an identification system 7. To recognize the identification transmitter 5 or to communicate with the identification transmitter, the identification system 7 has a communication module 7.1 This communication module exchanges radio signals with the identification transmitters 5 via ultra-wideband communication, for example. Any radio technology, e.g., mobile radio, wifi, Bluetooth, or the like can however be used.

An environment monitoring system 12 is further connected to the control device 10. The control device 10 receives control signals from at least one vehicle camera 8, at least one vehicle microphone 9, a spacing sensor 13, for example in the form of a spacing radar and/or an ultrasound sensor, and from at least one laser scanner 14, such as a lidar. At least one brightness sensor 15 is additionally connected to the environment monitoring system 12, using which a current environment brightness in an environment around the vehicle 2 can be determined. Using the environment monitoring system 12, a nearing of the authorized person to the vehicle 2 can additionally be validated. The environment lighting device 1 can also be operated exclusively only if the brightness sensor 15 determines a sufficient darkness in the environment of the vehicle 2. Using an engine control device 16, an activated or deactivated engine, in particular in the form of a drive engine of the vehicle 2 can be seen. If the drive engine is deactivated, this indicates a stationary or parked vehicle 2, wherein operation of the environment lighting device 1 is excluded when a vehicle 2 is moving as long as the vehicle 2 exceeds a pre-determined vehicle speed. The vehicle speed can, for example, be determined using different vehicle sensors, for example a wheel rotational speed sensor and/or an evaluation of a current geoposition of the vehicle using a global navigation satellite system.

An interior monitoring system 17 is further connected to the control device 10. Using the interior monitoring system 17, a vehicle interior can be monitored to monitor seat occupation and/or behavior of a vehicle occupant, for example to be able to detect a vehicle occupant's desire to exit. For this purpose, the interior monitoring system 17 receives sensor signals from several sensors. These include a vehicle interior camera 18, at least one vehicle interior microphone 19, at least one seat occupancy sensor 20, at least one touch sensor 21 integrated into at least one door grip of a vehicle door to detect the door grip being touched, and at least one inertial sensor 22, using which an acceleration of the vehicle 2 can be determined in any direction. Using the inertial sensor 22, it is recognized that the vehicle 2 is bumped into, wherein a direction can also be calculated from which the vehicle 2 was bumped into.

An operating device 23 is further connected to the control device 10, wherein the control device 10 can generally also be integrated into the operating device 23. The operating device 23 comprises a display 24 and an operating element 25. The operating device 23 can, for example, be a head unit of the vehicle 2. The display 24 can be any display, such as a combination instrument, a display of a central on-board computer, or the like. The operating element 23 can, for example, be a touch screen or a physical switch, button, rotary knob, or the like. It can also, for example, be comprised by an instrument panel of the vehicle 2. An authorized person or a person driving the vehicle can set the environment lighting device 1 to a standby mode via the operating element 25 so that the environment lighting device 1 emits light when an authorized person nears the vehicle 2. If, however, the environment lighting device 1 is not operated in the standby mode, then it also emits no light in the presence of the authorized person in the detection range 6 around the vehicle 2. An undesirable emission of light is thus prevented. The control device 10 further comprises a computer program product 26, in particular in the form of control software. This can be a computer program product 26 specific to the vehicle type.

FIG. 2 shows an aerial view of a vehicle 2 that casts a light pattern 4 into an environment of the vehicle 2 using a method according to the invention. The vehicle 2 is, in particular, a transporter or van. The vehicle 2 comprises exactly five lighting assemblies 3, using which an uninterrupted light carpet can be generated around a lateral and rear region of the vehicle 2. At least the environment regions around the vehicle 2 are lit that border doors of the vehicle 2. This enables the vehicle 2 to be comfortably entered or exited, loaded or unloaded, and the location of dropped objects in darkness. It is additionally conceivable that the vehicle 2 enlarges an environment region occupied by the light pattern 4 using vehicle headlights 27 and/or further auxiliary lights 28, in particular to generate an uninterrupted light carpet continuing completely around a periphery of the vehicle 2. The light carpet or the light pattern 4 can also run partially under the vehicle 2.

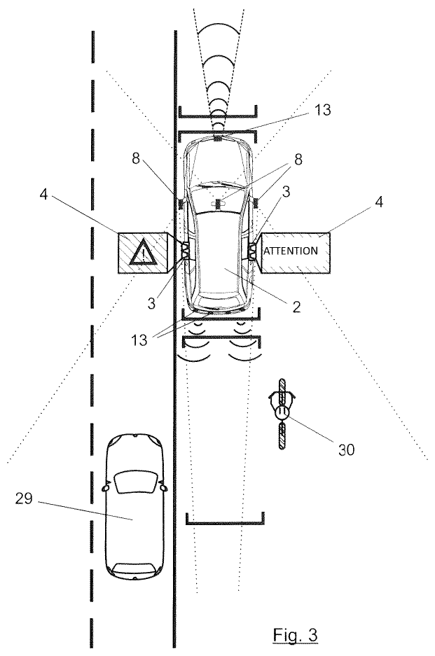

FIG. 3 shows a traffic situation in which the vehicle occupants wish to exit a parked vehicle 2, but further traffic participants in the form of an approaching vehicle 29 and a cyclist 30 are nearing the vehicle 2. The further vehicle 29 and the cyclist 30 are recorded using environment sensors of the vehicle 2, in particular using vehicle cameras 8, spacing sensors 13, and/or a laser scanner 14 (not depicted in FIG. 3). By evaluating a relative position between the vehicle 2 and the further vehicle 29 and the cyclist 30, and a movement direction and movement speed of the further traffic participants, the vehicle 2 or the control device 10 comprised by the vehicle 2 is in a position to calculate whether one of the further traffic participants will shortly enter the entry and/or exit region of the vehicle 2, i.e., whether there is a threat of collision with the vehicle 2 if one of the doors of the vehicle 2 is opened. If this is the case, and if a vehicle occupant additionally wishes to leave the vehicle, which can, for example, be determined by interior monitoring, then a corresponding light pattern 4 is projected into the environment by the environment lighting device 1 or the lighting assemblies 3 to warn the further traffic participants and the vehicle occupants exiting the vehicle 2. The light pattern 4 can be perceived both by the further traffic participants and by the vehicle occupants, whereby both can be warned before a potential collision. The light pattern 4 can, in particular, be projected into the environment with a warning color such as bright red and have warnings, for example warning text and/or a warning symbol. The light pattern 4 is additionally provided with dynamics that increase perception of the light pattern 4. The light pattern 4 can thus pulse, move, and/or flash like a stroboscope. If, by contrast, there were no further traffic participants in a close environment of the vehicle 2, the light pattern 4 can be cast into the environment with a different characteristic. For example, the light pattern 4 can have a green color and no dynamics. Safety in road traffic can thus be improved.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9. (canceled)

10. A method for operating an environment lighting device of a vehicle, the method comprising:
receiving an inputted control action to set the environment lighting device into a standby mode; and
emitting, by the environment lighting device, at least one light pattern into an environment of the vehicle using at least one lighting assembly when an authorized person nears the vehicle while the environment lighting device is in the standby mode.

11. The method of claim 10, wherein a person is recognized as the authorized person based on at least one of the following:
an identification transmitter entering into a detection range of an identification system of the vehicle, wherein the identification transmitter is a vehicle key, transponder, or a mobile device;
evaluating at least one camera image generated by at least one vehicle camera using facial recognition; or
evaluating an audio signal output by at least one vehicle microphone, wherein the audio signal comprises at least one key word or key sentence spoken by the authorized person, and wherein vocal characteristics of the authorized person are analyzed.

12. The method of claim 10, further comprising:
determining whether a vehicle occupant desires to leave the vehicle; and
casting, responsive to determining that the vehicle occupant desires to leave the vehicle, the at least one light pattern into the environment by the environment lighting device, wherein the at least one light pattern has a different color, shape, surface area, pattern, brightness, luminous range, or dynamics depending on whether it is possible for the vehicle occupant to exit the vehicle without risk or whether there is a risk of a potential accident for the vehicle occupant to exit the vehicle.

13. The method of claim 12, wherein, in addition to the light pattern cast into the environment, interior lighting of the vehicle is activated depending on a safe or unsafe exit.

14. The method of claim 10, further comprising:
determining whether an attempted break-in or damage to the vehicle is detected; and
emitting, by the environment lighting device, light that exclusively illuminates a relevant environment region based on the determined attempt to break-in or damage the vehicle.

15. The method of claim 10, wherein, at least when at least one vehicle door is opened, the environment lighting device projects information into the environment, wherein information content of the projected information is changed depending on seat occupation of a vehicle seat neighboring the opened door, wherein seat occupation is monitored by a camera monitoring of the vehicle interior or by a seat occupation sensor.

16. A vehicle, comprising:
a lighting device;
an identification system; and
at least one control device coupled to the lighting device and the identification system, wherein the control device is configured to
receive an inputted control action to set the environment lighting device into a standby mode; and
control the environment lighting device to emit at least one light pattern into an environment of the vehicle using at least one lighting assembly when an authorized person nears the vehicle while the environment lighting device is in the standby mode.

17. The vehicle of claim 16, wherein a projector equipped to show information of the lighting device is integrated into a sill cladding, undercarriage cladding, or a bumper of the vehicle.

18. The vehicle of claim 16, wherein the lighting device comprises exactly five lighting assemblies, wherein two lighting assemblies of the exactly five lighting assemblies are respectively arranged on a left and right side of the vehicle when viewed in relation to a longitudinal axis of the vehicle, and one lighting assembly of the exactly five lighting assemblies is arranged at a rear of the vehicle, and wherein the exactly five lighting assemblies are configured to project an interrupted light pattern into the environment.
